(19) United States
(12) Patent Application Publication
(10) Pub. No.: US 2004/0112439 A1
(43) Pub. Date: Jun. 17, 2004

(54) Safety-container assembly for receiving hazardous liquids, in particular an organic peroxide

(76) Inventors: Hans-Peter Eisenhut, Berg (DE); Manfred Maier, Reitmehring (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/468,120

(22) PCT Filed: Feb. 14, 2002
(86) PCT No.: PCT/EP02/01592

(30) Foreign Application Priority Data
Feb. 15, 2001 (DE) 101 07 155.8

(51) Int. Cl. F17D 1/00

(52) U.S. Cl. 137/576

(57) ABSTRACT

The invention relates to a safety container arrangement (10) for holding hazardous liquids, especially an organic peroxide (OP). It is envisaged, according to the invention, that the safety container arrangement (10) has receiving spaces (12, 14) separated from one another, of which at least one first receiving space (12) serves for holding the hazardous liquid (OP) and at least one second receiving space (14) serves for holding another liquid (V) miscible with the hazardous liquid (OP) for lowering the potential risk, especially a liquid (V) for diluting and/or neutralizing the hazardous liquid (OP). At least one connection (106) is provided between the receiving spaces (12, 14), which is closed by at least one safety mechanism (16), which in the case of danger releases the at least one connection (106) and permits mixing of the liquids (OP, V).

The invention relates to a safety container arrangement for receiving hazardous liquids, especially an organic peroxide.

Organic peroxides are relatively unstable compounds. Their use as indicators in the polymerization of monomers and in the crosslinking of polymers is in fact based on their reactivity, i.e. their breakdown into free radicals. In their pure form, many organic peroxides are sensitive to impact or are even explosive, and are regarded as “hazardous materials”, i.e. they may only be transported, stored and handled under certain conditions. The dangers arising from them must be kept under control and excluded in practice by observing certain regulations. These regulations cover among other things the type of packaging, restriction of the quantities of peroxide in the packages, and safety advice for transport, storage and handling. The transport regulations permit various types of packaging, which depend on the hazardousness and thermal stability of the products in question. Some liquid preparations are permitted to be transported in polyethylene-lined iron drums or small containers or even in large tank trucks. However, the majority of liquid products are packed in polyethylene drums (self-supporting or with a cardboard casing). This last-mentioned type of packing is generally recommended nowadays, for the following reason: in a metallic container, any decomposition of peroxide can possibly cause an explosion, owing to the associated increase in pressure. Flexible plastics drums burst, melt or burn, before the internal pressure of the breakdown products reaches a dangerous level.

Furthermore, for each product the transport regulations stipulate the permitted maximum amount per shipping drum. Normally the drums can contain 25 to 50 kg peroxide in delivery form. In some cases, e.g. with particularly temperature-sensitive preparations or explosive products, the permitted quantity is greatly reduced, for example to 5 kg peroxide in delivery form per drum. Subdivision into smaller packing units means that local decomposition of peroxide does not affect the entire shipment immediately, but can only spread from one drum to another with a considerable delay.

In the case of peroxide indicators, explosiveness is an undesirable property, which can be moderated to any desired extent or eliminated entirely by appropriate dilution with suitable inert substances, without adversely affecting the intended action, i.e. the supply of free radicals. Liquid inert substances, such as water and certain organic plasticizers and solvents, are suitable for desensitization, i.e. reducing the hazardousness. Even high-explosive peroxides are no longer explosive when sufficiently diluted with these inert substances to a peroxide concentration of for example 10 to 20 wt. %, though they are still combustible. In general, however, both the manufacturers and the processors of organic peroxides are interested in avoiding desensitization if possible or limiting it to the minimum. On the one hand the desensitizing agents are only ballast materials that involve expenses, and on the other hand they often interfere with processing.

In contrast, the aim of the invention is to provide a safety container arrangement for receiving hazardous liquids, especially an organic peroxide, which makes it possible to transport larger quantities of organic peroxides of higher concentration.

This aim is achieved according to the invention with a safety container arrangement for receiving hazardous liquids, especially an organic peroxide, with receiving spaces that are separate from one another, of which at least one first receiving space serves for receiving the hazardous liquid and at least one second receiving space serves for receiving another liquid that is miscible with the hazardous liquid to lower the potential risk, in particular a liquid for diluting and/or neutralizing the hazardous liquid, with at least one connection being provided between the receiving spaces, which is sealed off by at least one safety mechanism, which in the case of danger releases the at least one connection and allows the liquids to mix together.

The central idea of the invention is that for example a thermally unstable substance such as an organic peroxide is only diluted to a concentration that excludes spontaneous ignition or deflagration under the given conditions if there is a dangerous situation. As already mentioned, liquid inert substances, e.g. water and certain organic plasticizers and solvents, are suitable for desensitization, i.e. for lowering the hazardousness. If, in a dangerous situation, for example owing to failure of a cooling device at elevated external temperatures, the organic peroxide reaches a critical temperature, above which there is a risk of spontaneous ignition or explosion of the organic peroxide, the safety mechanism releases the connection between the receiving spaces and thus permits mixing of the liquids.

As far as the arrangement of the receiving spaces is concerned, it can for example be envisaged that several smaller receiving spaces for receiving the hazardous liquid are provided, which are connected via correspondingly many safety mechanisms to one single large receiving space for holding the diluting and/or neutralizing liquid. With a large number of receiving spaces for holding the hazardous liquid arranged for example on a tank truck, if just one single receiving space reaches a dangerous temperature level on account of inadequate cooling, it is only necessary to dilute the hazardous liquid contained in the single critical receiving space, whereas no mixing takes place in the other receiving spaces.

Preferably, however, it is envisaged that the receiving spaces, which are separated from one another, are arranged in pairs, with the cubic capacity of the additional container dimensioned so that in the two communicating containers, after dilution, there is a safe peroxide concentration that can be handled in conventional drums. If the organic peroxide and the other liquid for dilution and/or neutralization have different densities, the receiving space for holding the liquid with the higher density can be arranged so that it is higher than the other receiving space. This arrangement permits spontaneous mixing of the two liquids as a result of the upward or downward movements of the two liquids induced by the pressure difference.

Even after the two liquids have mixed together, in order to ensure that an excess pressure arising as a result of decomposition of the organic peroxide cannot cause the safety container arrangement to be damaged and on the other hand to ensure in such a case that only a limited amount of organic peroxide escapes, it is proposed that at least the receiving space arranged in the higher position should have a pressure relief device especially in the form of a bursting disk. The said bursting disk can for example be provided in a manhole cover.

In order to keep the construction volume of the safety container arrangement small, it is proposed that the two receiving spaces should be arranged one above the other in one container, separated from one another by a partition. In this way we are also able to ensure a more uniform temperature distribution over the two receiving spaces and moreover it makes it possible, by cooling just one receiving space, to cool the other receiving space as well.

In order to be able to ensure a simple but pressure-proof construction, it is proposed that the first receiving space should have a top with convex dishing at least in the peripheral zone, a bottom with convex dishing at least in the peripheral zone, and a shell joining the top and bottom together, and that the second receiving space should be formed from a dish-shaped part of the container, which fits in the convex dishing of the bottom of the first receiving space. This construction ensures that the receiving space for holding the hazardous liquid possesses a pressure-stable construction, whereas the second receiving space for holding the diluting and/or neutralizing liquid has a simpler and therefore less expensive construction, with the second receiving space preferably positioned on a seam-free zone of the “pressure vessel”. It is therefore possible to transport the hazardous liquid even at higher pressures, if this is for example beneficial for the transport behaviour, whereas it is rather unlikely that there would be such a need for the diluting and/or neutralizing liquid. Moreover, the fact that the first receiving space can withstand pressure can ensure that when there is a rapid increase in pressure in the first receiving space, the safety mechanism is triggered and the associated pressure drop in the first receiving space cannot cause it to be damaged.

In order to ensure on the one hand that the material of the receiving spaces is resistant to the hazardous liquid and the diluting and/or neutralizing liquid used and to ensure, on the other hand, that the material used does not exert an action that causes decomposition, it is further proposed that the receiving spaces and the fittings used should consist of special steel or pure aluminium. It would, however, also be conceivable to use glass, porcelain or suitable plastics, for example polyethylene.

In accordance with the invention, the safety mechanism can also comprise a valve mechanism. This may consist, for example, of electrically, hydraulically or pneumatically driven valve mechanisms of any design. For simpler and less expensive manufacture, however, it is proposed that the valve mechanism should comprise a valve disk pretensioned in the direction of opening by a helical pressure spring, and held in its sealed position by a fusible device held between the side of the valve disk away from the pressure spring and a distance piece. It is possible, for example, to use glass bulbs as the said fusible device, which are obtainable for any temperatures and their contents cannot cause a reaction with the hazardous liquid. Alternatively, it can be envisaged that the glass bulbs contain inhibitors, which stop the reaction when they are released.

To ensure rapid and reliable opening of the valve mechanism, it is proposed that the helical pressure spring should be fitted near the edge of the valve disk, a guide collar should start from a valve seat and expand outwards in the direction of opening, and the valve disk should have a blade-like edge on its external side. This arrangement ensures that the valve disk cannot assume an oblique position during opening, and that even with the valve disk in an oblique position, its jamming is excluded and its friction is reduced.

To ensure high operational reliability of the valve mechanism over a long period even with storage of a highly aggressive hazardous liquid, e.g. an acid, and at the same time permit optimum flow through the valve mechanism, it is further proposed that the valve mechanism should be arranged in an inclined zone of the partition in such a way that the side of the valve mechanism near the pressure spring is opposite the hazardous liquid. With this design it is possible, for example, for the energy storing device of the valve mechanism to be made of conventional spring steel and be provided with a coating of polyethylene or some other plastic which is not intended to be exposed to the hazardous liquid permanently.

Furthermore, it can be envisaged that the second receiving space has an overflow, extending from the bottom of the receiving space to near the top of the receiving space. With this arrangement it is possible to ensure, on the one hand, that the receiving space can be filled to a predetermined level without raising its internal pressure, while at the same time the fittings provided on the bottom of the container are protected from damage. On the other hand it is possible, by early closure of the overflow, to effect a defined pressure rise in the second receiving space, i.e. to produce a gas bubble with an increased pressure, which permits accelerated mixing by the rising gas and/or forcing-out of the diluting and/or neutralizing liquid when the connection is opened between the two receiving spaces.

To permit accelerated mixing of the liquids, it is proposed as a further development of the invention that the safety mechanism should comprise a device that produces forced circulation of the liquid through the two receiving spaces. Such a device might for example be a membrane or piston arrangement, with which it would be possible for example to cause displacement of liquid as a result of a reduction in volume of the second receiving space. Alternatively a pump arrangement can be provided, which produces forced circulation of the two liquids.

The invention also relates to the use of a safety container arrangement for the transport and/or storage of organic peroxides. Depending on the sensitivity of the organic peroxide to the action of heat, it can be envisaged that the transport and/or storage of the organic peroxide takes place at room temperature or at slightly raised temperature in the range from 20° C. to 50° C., preferably in the range from 20° C. to 30° C., or at temperatures below room temperature in the range from −40° C. to 20° C., preferably in the range from −25° C. to 20° C.

### In the following, examples of application of the invention will be explained in more detail on the basis of a drawing.

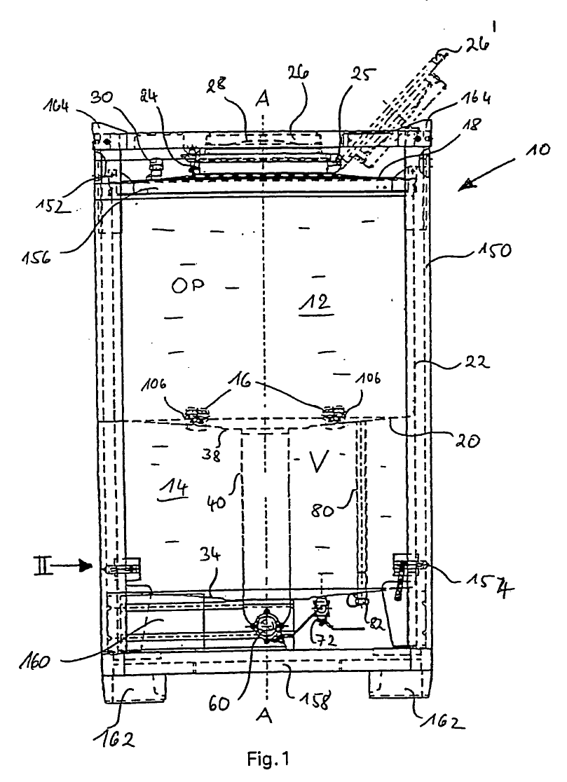

FIG. 1 shows a cut-away side view of a safety container arrangement according to the invention;

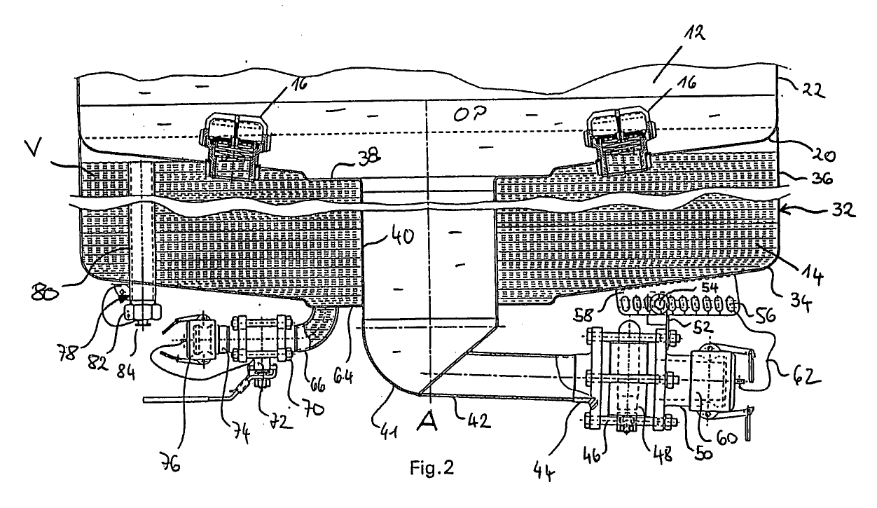

FIG. 2 shows a cut-away side view of the safety container arrangement on an enlarged scale in viewing direction II in FIG. 1;

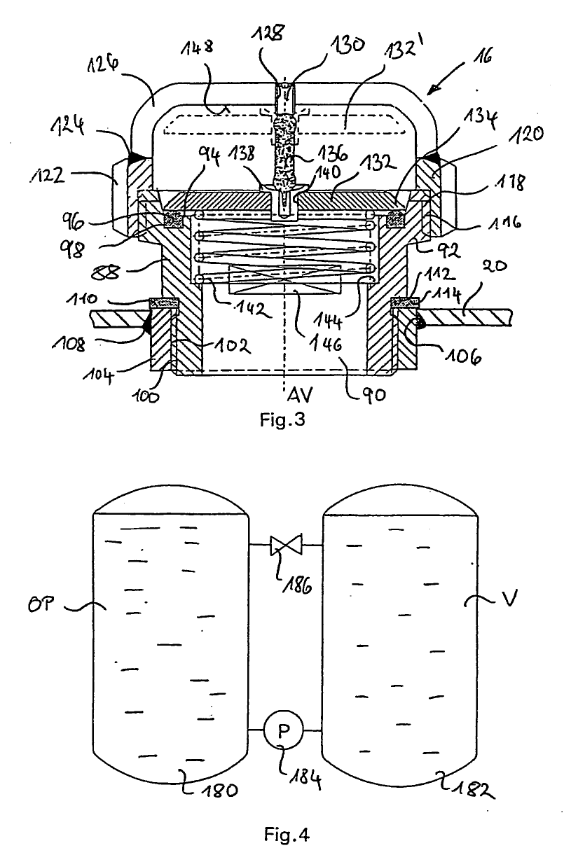

FIG. 3 shows a cut-away side view of a valve mechanism on an enlarged scale; and

FIG. 4 shows a simplified view of a further safety container arrangement according to the invention, which is provided with a device for forced circulation.

In FIG. 1, the safety container arrangement according to the invention is in general designated 10. It comprises a first receiving space 12 for holding an organic peroxide OP and a second receiving space 14 for holding another liquid that is miscible with the organic peroxide for lowering the potential risk, in particular a liquid V for diluting the organic peroxide OP. Between the receiving spaces 12, 14 we can see two valve mechanisms 16, which in the case of danger release a connection between the two receiving spaces 12 and 14 and permit the liquids OP and V to mix together.

As can be seen in FIGS. 1 and 2, the first receiving space 12 comprises a convex-dished top 18, a bottom 20 that slopes from all directions towards the centre and a shell 22 that joins the top 18 and the bottom 20 together. The top 18 is provided in a central region with a manhole 24, which can be closed with a screw cover 26 hinged at 25, shown both in its closed and in its opened position in FIG. 1, designated 26′, and has a pressure relief device in the form of a bursting disk 28. Furthermore, the top is provided with a pressure equalizing device 30, which permits ventilation or venting of the first receiving space 12 when it is being filled or emptied.

As can be seen in particular in FIG. 2, the second receiving space 14 is formed by a pot-shaped or dish-shaped container part 32, which is formed from a bottom 34 that slopes towards the centre from all directions and a shell 36, which is joined in a suitable manner to a convex-dished peripheral zone of the bottom 20 of the first receiving space 12. It should be pointed out in particular that the individual ends 18, 20 and 34 each have convex dishing at least in the peripheral zone and run parallel to the container axis A in the region where they are joined to the respective shell 22, 36, with the joining region between the shell 36 and the bottom 20 lying in a seam-free zone.

As can be seen from FIG. 2, the bottom 20 of the first receiving space 12 terminates in a plate-shaped collecting vessel 38, which is connected to a tubular section 40, which passes through the second receiving space 14 and the bottom 34 in the axial direction A downwards, ending in a hemispherical cap 41, to which a discharge nozzle 42 is connected by a flange 44. A valve 48 and a quick coupling 50 are flanged on this by means of fixing screws 46, the quick coupling 50 additionally being joined by means of a holding angle 52 and a fixing screw 54 with a series of slots 56 to a retaining strap 58 fitted to the underside of bottom 34. The quick coupling 50, which serves for connecting hose lines that are not shown, is closed on the outgoing side by a cap 60, which is secured to the retaining strap 58 by means of a retaining device 62.

The bottom 34 of the second receiving space 14 also has, at its lower end, a plate-shaped collecting vessel 64, which on the one hand is welded to the tubular section 40 and on the other hand has a further discharge nozzle 66, ending in a flange 68, which is connected by means of fixing screws 70 to a valve 72 and a quick coupling 74 that is closed with a cap 76.

In its region near the edge, the bottom 34 of the second receiving space 14 is provided with a venting device in the form of an overflow 78, which extends from the underside of the bottom 34 to close to the top of the receiving space 14. The overflow 78 has a riser 80, closed at the bottom end by a metal screw cap 82 with a pressure equalizing device 84.

Referring to FIGS. 2 and 3, we can see the valve mechanism 16, which is arranged in an inclined zone of the bottom 20. Valve 16 has a valve body 88, through which a flow channel 90 passes. At its upper end the valve body 88 has a guide collar 92, which expands from a valve seat 94 outwards in the direction of opening. Valve seat 94 consists essentially of an O-ring 96, which is held in a circular groove 98 pointing in the axial direction AV of valve body 88.

At its bottom end, valve body 88 has external thread teeth 100, which engage with the internal thread teeth 102 of a sleeve 104 which is inserted into an opening 106 in the bottom 20 and is fixed there by a weld seam 108, with a seal 114 being provided between one end 110 of sleeve 104 near the valve and a seating 112 provided on the outer periphery of the valve body 88.

The guide collar 92 at the top end of valve body 88 has teeth 116 on its outer periphery, which engage with internal teeth 118 of a sleeve 120, which has a corrugated surface 122 on its outer periphery, by means of which the sleeve 120 can be screwed onto the guide collar 92. At its top end, sleeve 120 is provided, by means of a welded joint 124, with a large number of straps 126, though only one of them is shown in FIG. 3. At its upper central end, strap 126 has a hole 128 which is provided with internal teeth, into which an adjusting screw 130 is screwed. The adjusting screw 130 is used for pressing a valve disk 132, which has a blade-like edge 134 on its outside, via a glass bulb 136 and a glass bulb seat 138, which is inserted in a hole 140 provided centrally in valve disk 132, onto its valve seat 94.

On the underside of valve disk 132, a helical pressure spring 142 is provided, which is supported on the one hand in the peripheral zone of the valve disk and on the other hand on a seat 144 provided on the inner peripheral surface of valve body 88. To permit secure screwing of valve body 88 into the sleeve 104, a recess 146 is provided on the outer periphery of valve body 44, and this recess serves as the bearing surface for a suitably dimensioned wrench.

If the temperature of the liquid contained in the first receiving space 12 exceeds a predetermined limit, the glass bulb 136 breaks, with the result that the helical pressure spring 142 lifts the valve disk 132 from the valve seat 94 and moves it towards the end of strap 126 opposite the valve disk, until the valve disk 132 comes up against the surface 148 of strap 126 opposite the valve disk 132, as is shown schematically by the valve disk 132′ drawn with a dot-and-dash line. Following valve opening, mixing of the two liquids OP and V occurs via valves 16 on account of the different densities of the liquids, with exchange flow between the two receiving spaces 12, 14 being further intensified by a volume of gas G rising from the lower receiving space 14, it being possible to adjust the said volume by means of the overflow 78.

As can be seen in particular from FIG. 2, the valve mechanism 16 is arranged in an inclined zone of the bottom 20 in such a way that the side of valve 16 next to the pressure spring is opposite the organic peroxide. With this arrangement it is possible, on the one hand, to achieve flow through valves 16 that is approximately in the axial direction A of the safety container arrangement 10, and on the other hand to ensure, with valve 16 still closed, that parts of valve 16 that are possibly peroxide-sensitive, for example the helical pressure spring 142, are only exposed to the aggressive liquid in an emergency.

For transport or storage, the outside of safety container 10 is provided with a carrying structure 150, which is attached by fixing screws 152 and 154 on the outside of the safety container and is held against it by rubber cushions (not shown) and by a hold-down frame 156 in the carrying structure. The region between a bottom frame 158 and the bottom 34 of the second receiving space 14 is protected all round by profiled plates 160. To permit the safe stacking of several safety containers 10 one above another, the carrying structure 150 has gripping shoes 162 in its lower corner regions and stacking corners 164 in its upper corner regions.

FIG. 4 shows a further embodiment of the invention, which has two receiving spaces 180 and 182 arranged side by side, which are connected together by means of an electric pump 148 and a valve 186. If, for example, a sensor arrangement (not shown) detects that the organic peroxide OP held in the first receiving space 180 reaches a critical temperature, the electric pump 184 and valve 186 (or even two electric pumps) are actuated, to effect forced circulation of the two liquids through the two receiving spaces 180, 182, to permit rapid mixing of the two liquids. Preferably the liquid with the lower density is pumped by pump 184 into the lower region of the respective other receiving space, which leads to additional acceleration of mixing of the liquids as a result of the additional rising and falling motion induced by the density differences.

1. A safety container arrangement for receiving hazardous liquids, especially an organic peroxide (OP), with receiving spaces (12, 14) that are separated from one another, of which at least one first receiving space (12) serves for holding the hazardous liquid (OP) and at least one second receiving space (14) serves for holding another liquid (V) miscible with the hazardous liquid (OP) for lowering the potential risk, especially a liquid (V) for diluting and/or neutralizing the hazardous liquid (OP), with at least one connection (106) provided between the receiving spaces (12, 14), which is closed by at least one safety mechanism (16), which in the case of danger releases the at least one connection (106) and permits mixing of the liquids (OP, V).

2. A safety container arrangement according to claim 1, characterized in that the receiving space (12) for holding the liquid with the higher density (OP) is arranged so that it is higher than the other receiving space (14).

3. A safety container according to claim 2, characterized in that at least the higher receiving space (12) has a pressure relief device especially in the form of a bursting disk (28).

4. A safety container arrangement according to one of the preceding claims, characterized in that the two receiving spaces (12, 14) are arranged one above the other in a container and are separated from one another by a partition (20).

5. A safety container arrangement according to one of the preceding claims, characterized in that the first receiving space (12) comprises a top (18) with convex dishing at least in the peripheral zone, a bottom (20) with convex dishing at least in the peripheral zone and a shell (22) joining the top (18) and the bottom (20) together, and in that the second receiving space (14) is formed by a dish-shaped container part (34, 36), which is fitted in the convex-dished zone of the bottom (20) of the first receiving space (12).

6. A safety container arrangement according to one of the preceding claims, characterized in that the receiving spaces (12, 14) consist of special steel or pure aluminium.

7. A safety container arrangement according to one of the preceding claims, characterized in that the safety mechanism comprises a valve mechanism (16).

8. A safety container arrangement according to claim 7, characterized in that the valve mechanism (16) comprises a valve disk (132) pretensioned in the direction of opening by a helical pressure spring (142), the said valve disk being held in its sealed position by a fusible device (136) held between the side of the valve disk (132) away from the pressure spring and a distance piece (126).

9. A safety container arrangement according to claim 8, characterized in that the helical pressure spring (142) fits in the peripheral zone of the valve disk (132), a guide collar (92) expands outwards from a valve seat (94) in the direction of opening and the valve disk (132) has a blade-like edge (134) externally.

10. A safety container arrangement according to claim 8 or 9, characterized in that the valve mechanism (16) is arranged in an inclined zone of the partition (20) in such a way that the side of the valve mechanism (16) next to the pressure spring is opposite the hazardous liquid (OP).

11. A safety container arrangement according to one of the preceding claims, characterized in that the second receiving space (14) has an overflow (78), which extends from the underside of the receiving space (14) to close to the top of the receiving space (14).

12. A safety container arrangement according to one of the preceding claims, characterized in that the safety mechanism comprises a device (184, 186) which causes forced circulation of the liquids (OP, V) through the two receiving spaces (180, 182).

13. Use of a safety container arrangement according to one of the claims 1 to 12 for transport and/or storage of organic peroxides.

14. Use of a safety container arrangement according to claim 13, characterized in that the transport and/or storage of the organic peroxide takes place at room temperature or slightly raised temperature in the range from 20° C. to 50° C., preferably in the range from 20° C. to 30° C.

15. Use of a safety container arrangement according to claim 13, characterized in that the transport and/or storage of the organic peroxide takes place at temperatures below room temperature in the range from −40° C. to 20° C., preferably in the range from −25° C. to 20° C.
